(19) United States
(12) Patent Application Publication
(10) Pub. No.: US 2025/0300692 A1
(43) Pub. Date: Sep. 25, 2025

(54) SPECTRUM SHARING METHOD THROUGH FREQUENCY HOPPING IN NON-TERRESTRIAL NETWORKS ARCHITECTURE

(71) Applicant: Kyungpook National University Industry-Academic Cooperation Foundation, Daegu (KR)

(72) Inventors: Hoki BAEK, Daegu (KR); Hyerim JEON, Daegu (KR)

(73) Assignee: Kyungpook National University Industry-Academic Cooperation Foundation, Daegu (KR)

(21) Appl. No.: 19/085,511

(22) Filed: Mar. 20, 2025

(30) Foreign Application Priority Data
Mar. 22, 2024 (KR) 10-2024-0039663

(51) Int. Cl. H04B 1/7143

(52) U.S. Cl. CPC H04B 1/7143

(57) ABSTRACT

The present disclosure relates to a spectrum sharing method that can prevent jamming attacks and frequency interference through frequency hopping when operating multiple units simultaneously in a non-terrestrial network. The spectrum sharing method through frequency hopping according to an embodiment of the present disclosure is a spectrum sharing method through fast frequency hopping (FFH) in a plurality of cells assigned with different frequencies, the spectrum sharing method including: identifying occupied frequencies assigned to a cell at which a communication unit is positioned and at least one adjacent cell, respectively; and changing collision frequencies matching the occupied frequencies in a preset hopping pattern in the communication unit to a frequency that is not the occupied frequencies.

### CROSS REFERENCE TO RELATED APPLICATION

The present application claims priority to Korean Patent Applications No. 10-2024-0039663, filed Mar. 22, 2024, the entire contents of which are incorporated herein for all purposes by this reference.

### BACKGROUND

### Technical Field

The present disclosure relates to a spectrum sharing method that can prevent jamming attacks and frequency interference through frequency hopping when operating multiple units simultaneously in a non-terrestrial network.

### Description of the Related Art

A Non-Terrestrial Network (NTN) is a concept that encompasses aerial or satellite-based communication platforms to extend a wireless communication coverage in areas where terrestrial networks are not deployed. In detail, a Non-Terrestrial Network (NTN) includes various hierarchical communication units, such as a Geostationary Earth Orbit (GEO) satellite, a Medium Earth Orbit (MEO) satellite, a Low Earth Orbit (LEO) satellite, a High Altitude Platform (HAP), an Unmanned Aerial Vehicles (UAV), and a Ground Node (GN).

Since such a Non-Terrestrial Network (NTN) can extend a communication coverage in military operational areas where terrestrial networks are limited, technology applications are being explored primarily by the military to establish a Network Centric Operational Environment (NCOE).

However, for a Non-Terrestrial Network (NTN) to be utilized in a Network Centric Operational Environment (NCOE), it is essential to apply a frequency hopping technology that can prevent eavesdropping while ensuring stable transmission of tactical data. However, according to currently available commercial technologies, frequency hopping among multiple communication entities is practically infeasible unless an ultra-wideband spectrum capable of hopping is secured.

### SUMMARY

An objective of the present disclosure is to enable units to share a spectrum while preventing frequency collision between units when operating multiple units simultaneously in a Non-Terrestrial Network (NTN).

The objectives of the present disclosure are not limited to those described above and other objectives and advantages not stated herein may be understood through the following description and may be clear by embodiments of the present disclosure. Further, it would be easily known that the objectives and advantages of the present disclosure may be achieved by the configurations described in claims and combinations thereof.

In order to achieve the objectives described above, a spectrum sharing method through frequency hopping according to an embodiment of the present disclosure is a spectrum sharing method through fast frequency hopping (FFH) in a plurality of cells assigned with different frequencies, the spectrum sharing method including: identifying occupied frequencies assigned to a cell at which a communication unit is positioned and at least one adjacent cell, respectively; and changing collision frequencies matching the occupied frequencies in a preset hopping pattern in the communication unit to a frequency that is not the occupied frequencies.

The present disclosure enables units to share a spectrum while preventing frequency collision between the units when simultaneously operating multiple units in the non-terrestrial network, thereby being able to achieve message security (MSEC) and transmission security (TSEC) required for military communication.

Further, the present disclosure has the advantage of making jamming attacks or eavesdropping significantly difficult by determining the number of time of fast frequency hopping (FFH) in consideration of the jamming generation probability.

Detailed effects of the present disclosure in addition to the above effects will be described with the following detailed description for accomplishing the present disclosure.

### BRIEF DESCRIPTION OF THE DRAWINGS

FIG. 1 is a diagram showing a non-terrestrial network architecture according to an embodiment of the present disclosure;

FIG. 2 is a flowchart showing a spectrum sharing method through frequency hopping according to an embodiment of the present disclosure;

FIG. 3 is a diagram illustrating a frequency hopping method of beams output from an aerial communication unit to a plurality of cells;

FIG. 4 is a diagram illustrating a frequency hopping method of a communication unit in an LEO beam;

FIG. 5A and FIG. 5B are diagrams illustrating an occupied frequency corresponding to each communication unit;

FIG. 6 is a diagram illustrating a collision frequency;

FIG. 7 is a diagram illustrating a method of changing a collision frequency; and

FIG. 8 is a flowchart showing a process of determining the number of frequencies in a hopping pattern of a communication unit.

### DETAILED DESCRIPTION

The objects, characteristics, and advantages will be described in detail below with reference to the accompanying drawings, so those skilled in the art may easily achieve the spirit of the present disclosure. However, in describing the present disclosure, detailed descriptions of well-known technologies will be omitted so as not to obscure the description of the present disclosure with unnecessary details. Hereinafter, exemplary embodiments of the present disclosure will be described with reference to accompanying drawings. The same reference numerals are used to indicate the same or similar components in the drawings.

Although terms “first”, “second”, etc. are used to describe various components in the specification, it should be noted that these components are not limited by the terms. These terms are used to discriminate one component from another component and it is apparent that a first component may be a second component unless specifically stated otherwise.

Further, when a certain configuration is disposed “over (or under)” or “on (beneath)” a component in the specification, it may mean not only that the certain configuration is disposed on the top (or bottom) of the component, but that another configuration may be interposed between the component and the certain configuration disposed on (or beneath) the component.

Further, when a certain component is “connected”, “coupled”, or “jointed” to another component in the specification, it should be understood that the components may be directly connected or jointed to each other, but another component may be “interposed” between the components or the components may be “connected”, “coupled”, or “jointed” through another component.

Further, singular forms that are used in this specification are intended to include plural forms unless the context clearly indicates otherwise. In the specification, terms “configured”, “include”, or the like should not be construed as necessarily including several components or several steps described herein, in which some of the components or steps may not be included or additional components or steps may be further included.

Further, the term “A and/or B” stated in the specification means that A, B, or A and B unless specifically stated otherwise, and the term “C to D” means that C or more and D or less unless specifically stated otherwise.

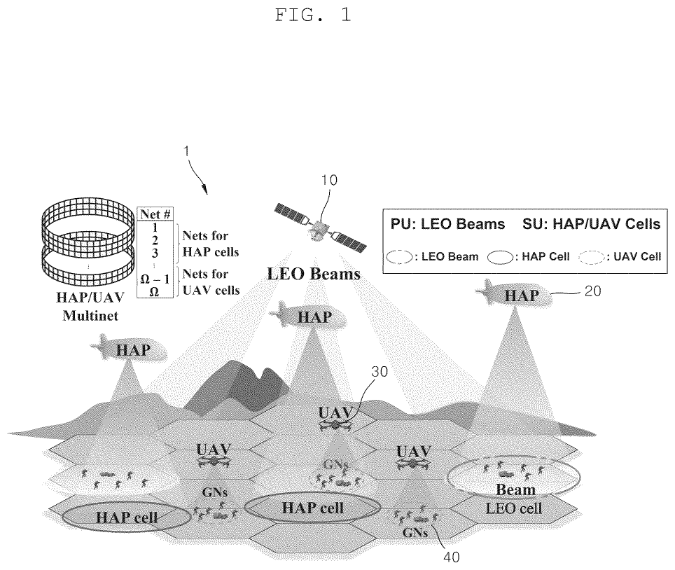

The present disclosure relates to a spectrum sharing method that can prevent jamming attacks and frequency interference through frequency hopping when operating multiple units simultaneously in a non-terrestrial network. Hereafter, a spectrum sharing method through frequency hopping according to an embodiment of the present disclosure is described in detail with reference to FIG. 1 to FIG. 8.

FIG. 1 is a diagram showing a non-terrestrial network architecture according to an embodiment of the present disclosure.

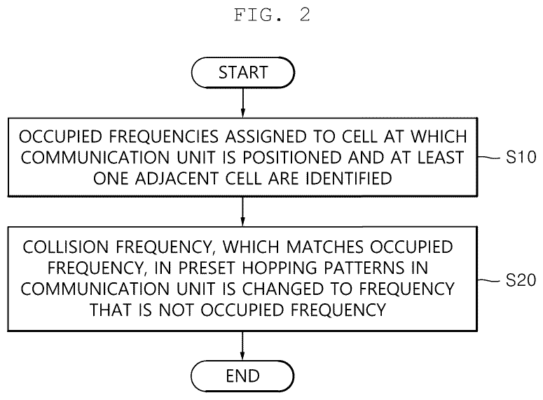

FIG. 2 is a flowchart showing a spectrum sharing method through frequency hopping according to an embodiment of the present disclosure.

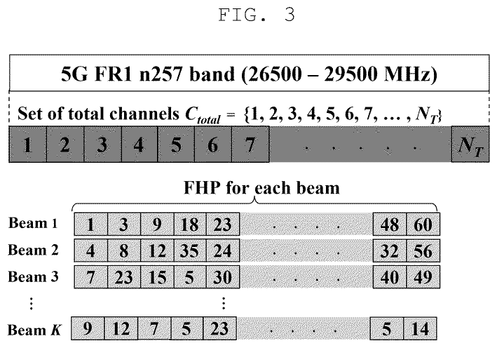

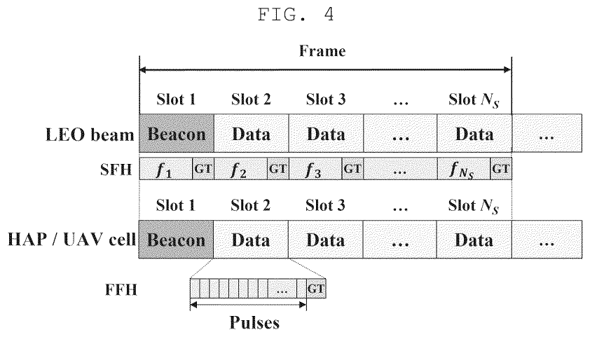

FIG. 3 is a diagram illustrating a frequency hopping method of beams output from an aerial communication unit to a plurality of cells and FIG. 4 is a diagram illustrating a frequency hopping method of a communication unit in an LEO beam.

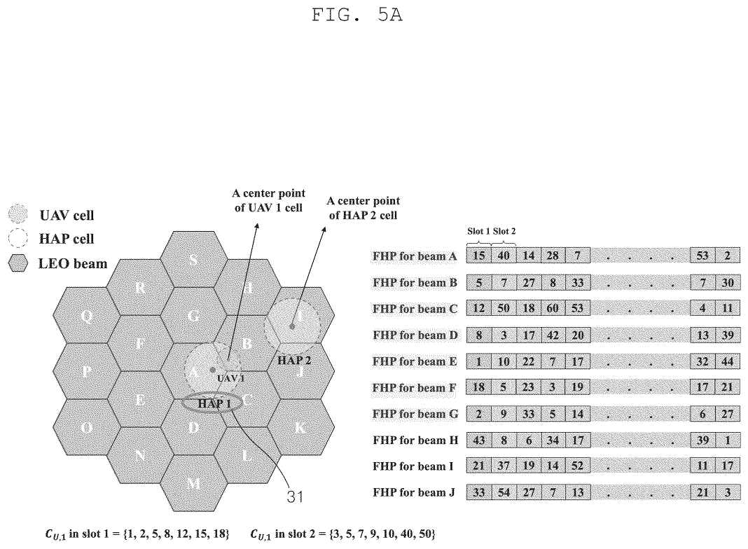

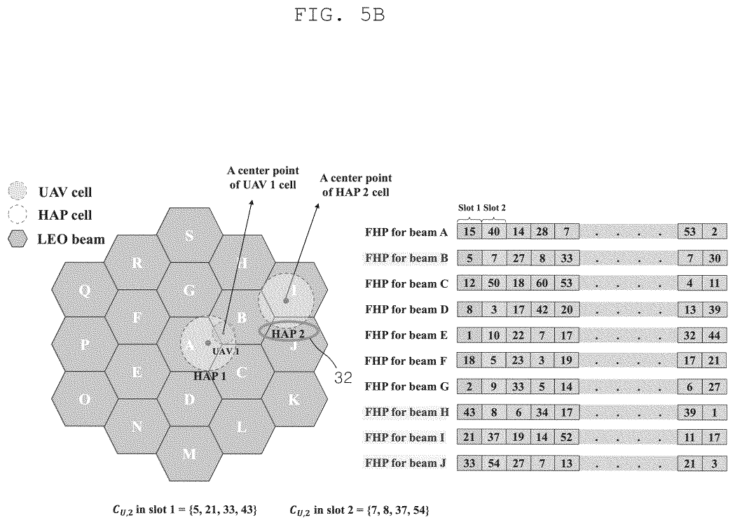

FIG. 5A and FIG. 5B are diagrams illustrating an occupied frequency corresponding to each communication unit.

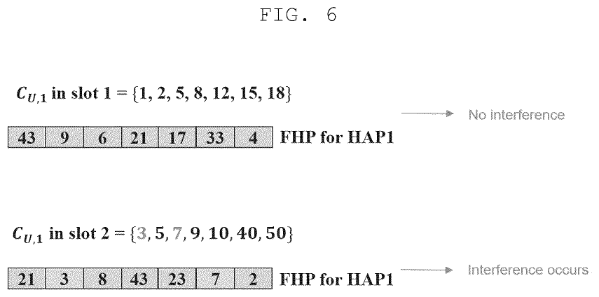

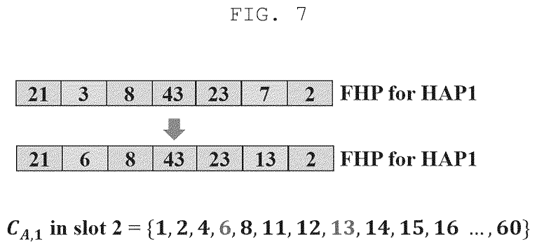

FIG. 6 is a diagram illustrating a collision frequency and FIG. 7 is a diagram illustrating a method of changing a collision frequency.

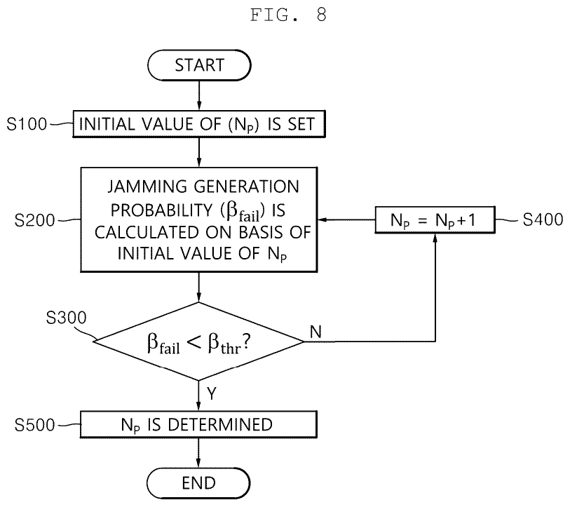

FIG. 8 is a flowchart showing a process of determining the number of frequencies in a hopping pattern of a communication unit.

Referring to FIG. 1, a Non-Terrestrial Network (NTN) 1 can be deployed to expand a communication coverage in military operation areas where terrestrial networks are limited, and may include various hierarchical communication entities such as a Low Earth Orbit (LEO) satellite 10, a High Altitude Platform (HAP) 20, an Unmanned Aerial Vehicle (UAV) 30, and a Ground Nodes (GN) 40.

In the architecture of the non-terrestrial network 1, all communication entities can communicate within a preset dedicated spectrum, and to this end, each communication entity can perform communication while hopping frequencies within the dedicated spectrum in accordance with a preset hopping pattern.

The present disclosure to be described below relates to a method in which plurality of lower-level communication entities shares a dedicated spectrum without overlapping frequency occupancy with other communication entities by performing rule-based fast frequency hopping (FFH).

In this specification, a communication refers to a communication entity and may be relatively defined. In detail, among the hierarchical communication entities shown in FIG. 1, communication entities in the relatively lower layers can be referred to as communication units. In an example, when a low earth orbit satellite 10 is a higher-level communication entity, the high altitude platform 20, the unmanned aerial vehicle 30, and the ground node 40 may be lower-level communication entities, that is, communication units. In another example, when the high altitude platform 20 is a higher-level communication entity, the unmanned aerial vehicle 30 and the ground node 40 may be lower-level communication entities, that is, communication units.

In the following description, it is assumed that a higher-level communication entity is the low earth orbit satellite 10 and a communication unit is the high altitude platform 20.

Referring to FIG. 2, the spectrum sharing method through frequency hopping according to an embodiment of the present disclosure relates to a method of sharing a spectrum through fast frequency hopping in a plurality of cells assigned with different frequencies, and may include a step of identifying occupied frequencies assigned to a cell at which a communication unit is positioned and at least one adjacent cell, respectively, (S10), and a step of changing a collision frequency, which matches the occupied frequency, in a preset hopping pattern in the communication unit, to a frequency that is not the occupied frequency (S20).

However, the spectrum sharing method shown in FIG. 2 is based on an embodiment, the steps of the present disclosure are not limited to the embodiment shown in FIG. 2, and if necessary, some steps may be added, changed, or removed.

The steps shown in FIG. 2 can be performed by a processor and the processor can perform the spectrum sharing operation by way of changing the hopping pattern of a communication unit. The processor may be electrically or mechanically connected with a communication unit as a control entity of the communication unit, and preferably, may be disposed in a communication unit.

In an example the processor may be implemented as a central processing unit (CPU), a graphic processing unit (GPU), etc., and may include at least one physical element of application specific integrated circuits (ASICs), digital signal processors (DSPs), digital signal processing devices (DSPDs), programmable logic devices (PLDs), field programmable gate arrays (FPGAs), a controller, and a micro-controller.

Before specifically describing the steps shown in FIG. 1, the architecture of the non-terrestrial network 1 to which the present disclosure is applied will first be described in detail.

Referring to FIG. 1 again, a plurality of cells may be virtual sections arranged in a predetermined pattern on the ground and may be defined by beams output from aerial communication units 10, 20, and 30. In this case, the aerial communication unit may be, for example, the low earth orbit satellite 10 as a higher-level communication entity, and the beams output from LEO cells may have different frequencies.

For example, as shown in FIG. 3, the dedicated spectrum set in the non-terrestrial network 1 may be 26,500-29,500 [MHz]. Within the given spectrum, the frequency may have 60 bands divided at 50 MHz intervals, and the frequencies of the bands may be indexed from Nos. 1 to 60, respectively.

In this case, the communication entities constituting the low earth orbit satellite 10 can share the spectrum while hopping the frequencies in accordance with a preset hopping pattern. In the example shown in FIG. 3, a first beam (beam 1) of the low earth orbit satellite 10 can hope a frequency in accordance with a preset hopping pattern of Nos. [1, 3, 9, 18, 23, . . . , 48, 60] and a second beam (beam 2) can hope a frequency in accordance with a hopping pattern a preset hopping pattern of Nos. [4, 8, 12, 35, 24, . . . , 32, 56]. The hopping pattern set in each beam may be set not to share the same frequency at the same time.

Meanwhile, the frequency assigned to each of a plurality of cells may be changed for each time slot in accordance with slow Frequency Hopping (SFH). In other words, the low earth orbit satellite 10 can change the beam output from each cell in accordance with slow frequency hopping (SFH).

Referring to FIG. 4, an LEO beam output from a low earth orbit satellite can be changed for a time slot in accordance with slow frequency hopping (SFH). In this case, the time slot may be defined as a time unit for transmitting one segmented frame, and accordingly, a subframe may be transmitted in one time slot.

In detail, the LEO beam may have a first frequency f₁ in a first slot, may hop to a second frequency f₂ in a second slot, and may hop to an N_{S}-th frequency in an N_{S}-th slot. For the stability of frequency hopping, the hopping operation may be performed with a predetermined guard time (GT).

In this case, communication units can share a spectrum through fast frequency hopping (FFH) according to preset hopping patterns in a plurality of cells each assigned with a frequency.

Referring to FIG. 4 again, a communication unit (e.g., HAP/UAV) can transmit data included in a subframe in a divided manner while hopping a frequency in a single time slot. For example, a communication unit can perform communication by way of transmitting only one pulse at each frequency that is hopped. A hopping pattern may be set in advance for each communication unit for fast frequency hopping, and the hopping patterns may be set not to share a frequency with not only other communication units, but higher-level communication entities (e.g., a low earth orbit satellite) performing slow frequency hopping (SFH) at the same time.

Meanwhile, such hopping patterns for respective communication entities are set such that communication frequencies do not collide with each other under the assumption that the positions of the communication entities are fixed, but the high altitude platform 20, the unmanned aerial vehicle 30, and the ground node 40 continuously move in the architecture of the non-terrestrial network 1 shown in FIG. 1, so there may be a problem that even though the communication entities hop frequencies in accordance with preset hopping patterns, frequencies collide at specific positions or at specific times.

The present disclosure is a method for solving this problem and the steps shown in FIG. 2 are described in detail hereafter.

The processor can identify occupied frequencies assigned to a cell at which a communication unit is positioned, and at least one adjacent cell in consideration of the possibility of movement of communication units. In this case, the occupied frequency may refer to a frequency that is determined for each time slot in accordance with slow frequency hopping (SFH).

In an example, referring to FIG. 5A, a first communication unit 31 may be positioned in a cell A defined by an LEO beam A. In this case, the first communication unit 31 can move to any one of adjacent cells from the cell A, so the processor can identify occupied frequencies assigned not only to the cell in which the first communication unit 31 is positioned, but at least one cell adjacent to the cell. In detail, in the example shown in FIG. 5A, the processor can identify the occupied frequencies C_{U,1} in slot 1 & 2 assigned to the cell A and adjacent cells B, C, D, E, F, and G in the first and second time slots as Nos. [1, 2, 5, 8, 12, 15, 18] and Nos. [3, 5, 7, 9, 10, 40, 50], respectively.

In another example, referring to FIG. 5B, a second communication unit 32 may be positioned in a cell I defined by an LEO beam I. In this case, the second communication unit 32 can move to any one of adjacent cells from the cell I, so the processor can identify occupied frequencies assigned not only to the cell in which the second communication unit 32 is positioned, but at least one cell adjacent to the cell. In detail, in the example shown in FIG. 5B, the processor can identify the occupied frequencies C_{U,2} in slot 1 & 2 assigned to the cell I and adjacent cells J, B, and H in the first and second time slots as Nos. [5, 21, 33, 43] and Nos. [7, 8, 37, 54], respectively.

Next, the processor can change a collision frequency, which matches an occupied frequency of the preset hopping patterns in the communication units, to a frequency that is not an occupied frequency (S20).

As described above, a hopping pattern for fast frequency hopping (FFH) may be set in advance in each communication unit and the hopping pattern may be set for individual time slot. The processor can identify a collision frequency, which matches an occupied frequency corresponding to a time slot, among a plurality of frequencies in the hopping pattern corresponding to the time slot.

Referring to FIG. 5A and FIG. 6 together, the hopping pattern set in the first communication unit 31 in the first time slot may be Nos. [43, 9, 6, 21,17, 33, 4]. As described above, since the occupied frequencies C_{U,1} in slot 1 for the first time slot are Nos. [1, 2, 5, 8, 12, 15, 18], there may not be a frequency matching the occupied frequency in the plurality of frequencies in the hopping pattern. In this case, since frequency collision does not occur in the first time slot, the operation for changing a frequency may not be performed.

On the other hand, the hopping pattern set in the first communication unit 31 in the second time slot may be Nos. [21, 3, 8, 43, 23, 7, 2] and the occupied frequencies for the second time slot C_{U,1} in slot 2 may be No. [3, 5, 7, 9, 10, 40, 50]. In this case, the processor can identify the frequencies No. 3 and No. 7 of the plurality of frequencies in the hopping pattern as collision frequencies that matches occupied frequencies. In this case, since frequency collision occurs in the second time slot, the operation for changing a frequency is required.

The processor can change the collision frequencies to a predetermined frequency excluding the occupied frequency in the dedicated spectrum of the non-terrestrial network 1.

Referring to FIG. 5A and FIG. 7 together, occupied frequencies for the first communication unit 31 in the second time slot are Nos. [3, 5, 7, 9, 10, 40, 50], that is, totaling seven. Accordingly, available frequencies C_{A,1} in slot 2 excluding the occupied frequencies in the dedicated spectrum may be Nos. [1, 2, 4, 6, . . . , 60], that is, a total of 53. The processor can change the collision frequency by selecting two certain frequencies from the available frequencies. Accordingly, in the second time slot, the first communication unit 31 can change the frequency through fast frequency hopping (FFH) in accordance with a changed hopping pattern.

However, when a collision frequency is arbitrarily changed, frequency collision does not occur when there is one communication unit in the non-terrestrial network 1, but frequency collision may occur between the communication units 31 and 32 when there are two or more communication units 31 and 32, as shown in FIG. 5A and FIG. 5B. In consideration of this matter, the processor can change a collision frequency in the manner described above.

In detail, the processor can calculate the sum of the index of an occupied frequency and the index of a communication unit, calculate the remainder obtained by dividing the calculated sum by the number of available frequencies within a spectrum excluding the occupied frequency, and change a collision frequency to the frequency of the order corresponding to the remainder of the available frequencies.

In detail, the operation of calculating the remainder by the processor can be performed in accordance with the following [Equation 1].

$$\hat{I} = ( i + {C}_{i , j} ) \% {N}_{A} \qquad [ Equation 1 ]$$

(where î is the remainder, i is the index of a communication unit, j is the index of an occupied frequency, and N_{A} is the number of available frequencies).

For example, as shown in FIG. 5A and FIG. 7, the indexes of the first and second communication units 31 and 32 may be the No. 1 and the No. 2, respectively. The processor may identify the indexes of occupied frequencies for the first communication unit 31 in the second time slot as the No. 3 and the No. 7, respectively, and may identify the index of the first communication unit 31 as 1. Accordingly, the processor can calculate the sums of the indexes of occupied frequencies and the index of the first communication unit 31 as 4 and 8, respectively.

Meanwhile, in the second time slot, the number of available frequencies C_{A,1} in slot 2 of the first communication unit 31 may be a total of 53 excluding the seven occupied frequencies, and the processor divides the sums of indexes calculated above by 53, thereby being able to calculate the remainders as 4 and 8.

The remainders calculated in this way can be expressed by the following [Equation 2] and [Equation 3], respectively.

$$= ( 1 + 3 ) \%53 = 4 \qquad [ Equation 2 ]$$

$$= ( 1 + 7 ) \%53 = 8 \qquad [ Equation 3 ]$$

Next, the processors can change the collision frequency to 6 and 13 corresponding to the orders of the remainders, that is, the fourth and the eighth among the available frequencies [1, 2, 4, 6, 8, 11, 12, 13, 14, 15, 16, . . . , 60] sorted in ascending order. Accordingly, the hopping pattern [21, 3, 8, 43, 23, 7, 2] set in the first communication unit 31 in the second time slot can be changed into [21, 6, 8, 43, 23, 13, 2], and the first communication unit 31 can hop frequencies in accordance with the changed hopping pattern.

As described above, the present disclosure enables units to share a spectrum while preventing frequency collision between the units when simultaneously operating multiple units in the non-terrestrial network 1, thereby being able to achieve message security (MSEC) and transmission security (TSEC) required for military communication.

Meanwhile, even in the hopping method described above, when a jamming attack by an attacker is generated, frequency collision may occur. The processor can determine generation of a jamming attack when frequencies continuously collide in a single time slot, so it can determine the number of frequencies in a hopping pattern in each tome slot of a communication unit to reduce the possibility of generation of jamming.

Referring to FIG. 8, the method of determining the number of hopping frequencies by the processor may include setting an initial value of the number of frequencies in a hopping pattern (S100), calculating a jamming generation probability β_{fail} on the basis of the initial value (S200), comparing the jamming generation probability β_{fail} and a reference value βₜₕᵣ (S300), increasing the number of frequencies in the hopping pattern when the jamming generation probability βfail is equal to or more than the reference value βₜₕᵣ (S400), and determining the current number of frequencies as the number of hopping frequencies for a single time slot when the jamming generation probability β_{fail} is less than the reference value βₜₕᵣ (S500).

However, the method of determining the number of hopping frequencies shown in FIG. 8 is based on an embodiment, the steps of the present disclosure are not limited to the embodiment shown in FIG. 8, and if necessary, some steps may be added, changed, or removed.

Hereafter, the steps shown in FIG. 8 are described in detail.

The processor can set an initial value of the number of frequencies in the hopping pattern of a single time slot (e.g., the number Nₚ of pulses transmitted in a single time slot) (S100). The initial value may be set as a sufficiently larger value than the number of available frequencies of each communication unit. However, it is preferable to set the initial value as a value that is the value obtained by multiplying the number of available frequencies by the number of times of continuous collisions so that the available frequencies can be continuously selected at least by the number of times of the continuous collisions in the operation of calculating a jamming generation probability to be described below.

Next, the processor can calculate the jamming generation probability on the basis of the initial value of the number of frequencies in the hopping pattern (S200). In detail, the processor can calculate the probability of continuous selection of the same frequency over the number of times of continuous collisions in the hopping pattern of a single time slot when each of frequencies in the hopping pattern is randomly selected from the available frequencies in accordance with the following [Equation 4].

$${β}_{fail} = {\sum }_{k = 0}^{γ - 1} ( \begin{matrix}{N}_{p} \\ k\end{matrix} ) {( \begin{matrix}1 \\ {N}_{A}\end{matrix} )}^{k} {( 1 - \frac{1}{{N}_{A}} )}^{{N}_{p} - k} \qquad [ Equation 4 ]$$

(where β_{fail} is a jamming generation probability, γ is the number of times of continuous collisions, Nₚ is the number of frequencies in a hopping pattern, and N_{A} is the number of available frequencies).

Next, the processor can compare the jamming generation probability β_{fail} with the reference value βₜₕᵣ In this case, the reference value βₜₕᵣ may be set as a desired value by a user, and for example, may be set as 1%, 5%, 10%, etc. When the jamming generation probability β_{fail} is equal to or more than the reference value βₜₕᵣ, the processor can reduce the jamming generation probability β_{fail} by increasing the number of frequencies in the hopping pattern (S400), and the operation of increasing the number of frequencies can be repeated until the jamming generation probability β_{fail} becomes less than the reference value βₜₕᵣ.

When the jamming generation probability β_{fail} becomes less than the reference value βₜₕᵣ, the processor can finally determine the increased number of frequencies as the number of the hopping frequencies for the single time slot (S500). Through this process, the processor can determine the optimal number of hopping frequencies that makes a jamming attack by an attacker difficult.

As described above, the present disclosure has the advantage of making jamming attacks or eavesdropping significantly difficult by determining the number of time of fast frequency hopping (FFH) in consideration of the jamming generation probability.

Although the present disclosure was described with reference to the exemplary drawings, it is apparent that the present disclosure is not limited to the embodiments and drawings in the specification and may be modified in various ways by those skilled in the art within the range of the spirit of the present disclosure. Further, even though the operation effects according to the configuration of the present disclosure were not clearly described with the above description of embodiments of the present disclosure, it is apparent that effects that can be expected from the configuration should be also admitted.

What is claimed is:

1. A spectrum sharing method through fast frequency hopping (FFH) in a plurality of cells assigned with different frequencies, the spectrum sharing method comprising:
identifying occupied frequencies assigned to a cell at which a communication unit is positioned and at least one adjacent cell, respectively, by means of a processor; and
changing collision frequencies matching the occupied frequencies in a preset hopping pattern in the communication unit to a frequency that is not the occupied frequencies by means of the processor.

2. The spectrum sharing method of claim 1, wherein the plurality of cells are virtual sections arranged in a predetermined pattern on the ground and are defined by beams output from aerial communication units.

3. The spectrum sharing method of claim 1, wherein the frequency assigned to each of the plurality of cells is changed for each time slot in accordance with slow frequency hopping (SFH).

4. The spectrum sharing method of claim 1, wherein the identifying of occupied frequencies includes identifying an occupied frequency for each time slot determined in accordance with slow frequency hopping (SFH).

5. The spectrum sharing method of claim 1, wherein the changing of collision frequencies includes:
identifying a collision frequency, which matches an occupied frequency corresponding to a time slot, among a plurality of frequencies in a hopping pattern corresponding to the time slot; and
changing the identified collision frequency to a certain frequency excluding the occupied frequency in the spectrum.

6. The spectrum sharing method of claim 1, wherein the spectrum is divided by a plurality of frequency indexes defined as different bands, respectively, and
the changing of collision frequencies includes:
calculating a sum of an index of the occupied frequency and an index of the communication unit;
calculating a remainder obtained by dividing the calculated sum by the number of available frequencies within the spectrum excluding the occupied frequency; and
changing the collision frequency to a frequency of the order corresponding to the remainder of the available frequencies.

7. The spectrum sharing method of claim 1, further comprising:
calculating a jamming detection failure probability in accordance with the following [Equation 1] by means of the processor,
$${β}_{fail} = {\sum }_{k = 0}^{γ - 1} ( \begin{matrix}{N}_{p} \\ k\end{matrix} ) {( \begin{matrix}1 \\ {N}_{A}\end{matrix} )}^{k} {( 1 - \frac{1}{{N}_{A}} )}^{{N}_{p} - k} \qquad [ Equation 1 ]$$
(where β_{fail} is the jamming detection failure probability, γ is the number of times of continuous collisions, Nₚ is the number of frequencies in the hopping pattern, and N_{A} is the number of available frequencies in the spectrum excluding the occupied frequency); and
increasing the number of frequencies in a hopping pattern for each time slot until the jamming detection failure probability becomes less than a reference value by means of the processor.

8. The spectrum sharing method of claim 7, wherein the number of frequencies in the hopping pattern is initially set as a value obtained by multiplying the number of available frequencies excluding the occupied frequency by the number of times of continuous collisions.
